(19) United States
(12) Patent Application Publication
(10) Pub. No.: US 2005/0240758 A1
(43) Pub. Date: Oct. 27, 2005

(54) Controlling devices on an internal network from an external network

(76) Inventors: Christopher J. Lord, Portland, OR (US); Ajay Garg, Portland, OR (US); Ulhas Warrier, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/815,396

(22) Filed: Mar. 31, 2004

(51) Int. Cl. H04L 9/00

(52) U.S. Cl. 713/153

(57) ABSTRACT

Various embodiments of the invention are illustrated, discussed and claimed. In some embodiments, disclosed are techniques for facilitating a control point on an external network to interact with a UPnP device on an internal network to which access is blocked by a gateway, firewall or other such device. In particular, various embodiments disclose how the UPnP Security protocol may be utilized by such an external control point to allow the control point to remotely send actions to, query the state of, and/or otherwise securely access desired internal network UPnP devices.

### RELATED APPLICATIONS

This application is related to co-pending application Ser. No. ______, bearing attorney docket number DOCKET P42390.P16367, filed on Aug. 5, 2003, entitled “METHOD, APPARATUS AND SYSTEM FOR ACCESSING MULTIPLE NODES ON A PRIVATE NETWORK” and which is commonly assigned to the assignee of the present invention.

### FIELD OF THE INVENTION

The invention generally relates to network management, and more particularly to controlling a device on an internal network behind a gateway/firewall from an external network outside the gateway/firewall, using a security protocol intended to be operable on the internal network.

### BACKGROUND

Universal Plug and Play (UPnP) provides a suite of protocols, e.g., Simple Service Discovery Protocol (SSDP) for device discovery, General Event Notification Architecture (GENA) for eventing, and Simple Object Access Protocol (SOAP), a control protocol built over the eXtensible Markup Language (XML). These protocols allow automatic discovery, control, and ability to receive events from peers on a network, e.g., an Internet Protocol (IP) based network.

UPnP is intended to provide a simplified, distributed, operating system independent, zero-configuration, unmanaged networking environment for home users. UPnP operates with both wired and wireless networks, and can be supported on most operating systems. In a UPnP network, peers are classified as either a “control point” (CP) or a “device”. Control points may actively search for devices, send actions and receive events from devices, while devices advertise themselves, perform actions for control points and send events to control points. Devices advertise themselves via a discovery protocol, e.g., SSDP, and offer services (collections of SOAP actions) that control points may invoke.

The base UPnP protocols do not provide security. The UPnP Forum charted a working group to add security to the base protocols. The resultant specification is known as “UPnP Security” See, e.g., Uniform Resource Locator (URL) www-upnp-org/download/standardizeddcps/UPnPSecurityCeremonies_{—}1_{—}0secure-pdf). See also URL www-upnp-org/standardizeddcps/documents/DeviceSecurity_{—}1-0cc_{—}001-pdf. (Note: to prevent inadvertent hyperlinks, periods in the preceding URLs were replaced with dashes.) Devices may implement UPnP Security to encipher, authenticate, and authorize (access control) actions from control points. UPnP Security was architected to operate within the constraints of the UPnP 1.0 base protocols. The UPnP 1.0 base protocols only support local area networks. Consequently it is not possible to securely access home network devices from an external network, such as the Internet using UPnP Security.

Some attempts have been made to provide access to internal network devices from external networks, including simply placing desired devices outside of an intermediate gateway/firewall (defeats security), translating embedded IP addresses in UPnP Device Description Documents and related URLs, and having two devices, one external and mirroring the state of its companion on the internal network. None of these approaches provide a straightforward technique for getting through gateway/firewall security while maintaining end-to-end security, e.g., public-key cryptosystem based security, as required for secure communication with UPnP Secured Devices.

It is assumed the reader is familiar with basic cryptography principles such as disclosed in the UPnP security specification identified above, or in well-known text references such as Cryptography and Network Security: Principles and Practice by William Stallings, Applied Cryptography. Protocols, Algorithms, and Source Code in C by Bruce Schneier, or the like.

### BRIEF DESCRIPTION OF THE DRAWINGS

The features and advantages of the present invention will become apparent from the following detailed description of the present invention in which:

FIG. 1 illustrates a system of devices according to one embodiment.

FIG. 2 illustrates a dataflow diagram according to one embodiment.

FIG. 3 illustrates a flowchart according to one embodiment.

FIG. 4 illustrates a suitable computing environment in which certain aspects of the invention may be implemented.

### DETAILED DESCRIPTION

UPnP Security defines a service to be added to each secured device that allows its security to be managed. In addition, UPnP Security defines a service and control point behavior for an application called a Security Console, which edits the Access Control List (ACL) of a secured UPnP device and controls other security functions of that Device. UPnP Security is a point to point session layer protocol; devices and control points must have direct TCP/IP network connections, and only UPnP traffic is transported. That is, it does not allow an intermediary to act as a proxy for the network session.

It is assumed the UPnP Security supports all UPnP devices, including “conventional” networking devices such as Internet gateways, firewalls, wireless access points, network storage, and the like, as well as “unconventional” devices such as home automation thermostats, door bells, door locks, lighting, etc. The illustrated embodiments may utilize the current UPnP Security specification without extension or modification, and may be incorporated into or utilized along with future versions of the UPnP security standard. It will be appreciated that illustrated embodiments may be incorporated into security protocols if used in other discovery and control framework, such as Apple Corporation's Rendezvous, Sun Microsystems' Jini, the Salutation Consortium's Salutation, any the like. However, for expository convenience, the present description draws most examples from the UPnP Security protocol.

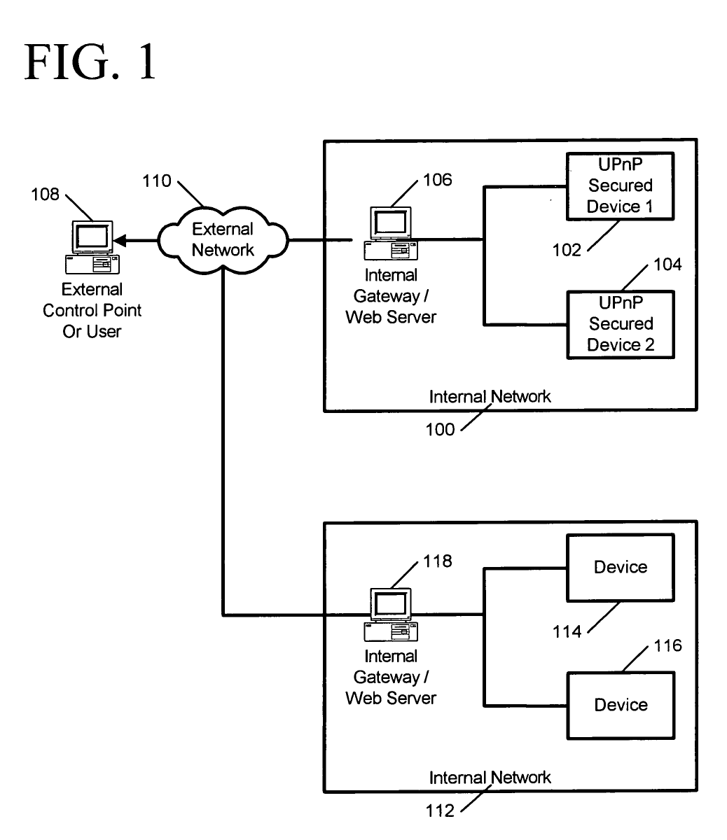

FIG. 1 illustrates a system of devices according to one embodiment in which an external control point/user may securely access (e.g., use the UPnP Security protocol to send actions to and query the state of) UPnP Secured Devices on an internal network from outside that network. As will be appreciated by one skilled in the art, the UPnP framework was not designed to allow access to devices from outside the internal network. It is assumed herein the reader is familiar with the UPnP Security protocol and related protocols such as the Simple Object Access Protocol (SOAP), the eXtensible Markup Language (XML), etc.

Illustrated are an Internal Network 100 of devices 102, 104, 106, and an external network 110, such as the Internet, wide area network (WAN), etc. Access by a device on the external network, such as a control point 108, to the internal network 100, occurs by way of traffic routed through a gateway/firewall 106 (hereafter generally “gateway”). The gateway divides networks into an “internal” portion 100 and an “external” portion 110. Often, the external network is the Internet, however it should be appreciated an internal network may be internally divided by gateways in which some portion of the internal network is treated as “external” to some other portion of the network. The gateway incorporates network traffic filters, or “firewall rules” determining what traffic may pass between the internal and external networks 100, 110.

It will be appreciated there may be multiple “internal networks,” e.g., 100, 112, each respectively having their internal network devices 102, 104, 114, 116 potentially accessible from an “external network” by way of their gateways 106, 118. Internal/external is a matter of perspective. From the perspective of internal networks 100, 112, “external” includes all networks on the external side of their gateways, hence from the perspective of internal network 100, “external” includes both networks 110 and 112, whereas from internal network 112, “external” includes both networks 100 and 110.

Matters become more complex when one factors in wireless networks. If the gateway supports wireless internal network clients, it becomes harder to maintain control over what traffic may appear on the internal network, e.g., a rogue control point may attempt to bypass the gateway and directly communicate with the internal network devices. In response to such concerns, the UPnP Working Forum promulgated the UPnP Security protocol discussed above to provide regulated and safe access to UPnP devices on the internal network from devices on the internal network.

At the junction of the home network and the broadband pipe a Residential Gateway (RG) or “home gateway” is typically deployed to restrict or partition home network traffic from public Internet traffic. Network Address Port Translation (NAPT) (also referred to as Network Address Translation (NAT)) is a technique used with IPv4 that maps or translates IP addresses between address realms. Typically, private non-routable IP addresses are used by nodes inside the home while public routable addresses are used by nodes on the Internet. NAPT multiplexes multiple private addresses into a single public address and is common in commercially shipping residential broadband gateways. NAPT operates on IP address headers as packets traverse from LAN private addresses to the WAN public address and vice-versa.

For each outbound TCP/UDP session NAPT keeps a translation table mapping local addresses and session port number to an assigned TCP/UDP port number on the public address interface. Inbound traffic for the session will arrive at the public interface and port number where it is forwarded to the corresponding local address and local port number.

The home gateway also typically disallows multicast UDP traffic originating in the home from traversing onto the Internet. The core UPnP discovery protocols use multicast UDP traffic for advertisement, as such UPnP does not natively operate over the Internet. The UPnP Working Forum promulgated the UPnP Security protocol to provide regulated and safe access to UPnP devices. Unfortunately, as noted above, the UPnP protocol does not provide for access by external UPnP control points devices on an external network. UPnP Security, based on the UPnP protocol is also bound to these restrictions. Currently the UPnP architecture only addresses discovery, eventing, and control of devices and control points on a local area network.

Thus, UPnP does not address the issue of accessing those devices from outside that network, nor does it provide for a secure method of accessing these devices. If an external device, such as external control point 108 desires to initiate contact with a device on the internal network 100, as will be discussed in more detail below, the gateway may facilitate the control point leaving the internal network 100 (where UPnP Security is operational) and continuing to control internal network devices from the external network. This may be achieved without the control point or the device requiring additions above and beyond UPnP core functionality, e.g., changes to the core UPnP protocol or UPnP Security Protocol.

It is assumed the control point 108 and a desired networked device, e.g., items 102, 104, may establish IP-based end-to-end communication inside the internal network as well as between the internal and external networks, e.g., a mutually authenticated secure session in accord with the UPnP Security protocol or other security protocol. Towards this end, it is assumed all network devices have a “global address”, such as an IPv6 address or IPv4 address. UPnP devices and control points may utilize non-routable private addresses, i.e. inside the home, additionally UPnP devices and control points may utilize public routable IP addresses on the home network as well as on the Internet. The illustrated embodiments require the underlying device or control point to support routable IP addresses. Additionally, the UPnP core protocols do not require that UPnP devices embed naming information in their description, as such; many UPnP devices use a literal IP address in their device description document. For a control point on an external network to connect to an UPnP device it is recommended devices have a Fully Qualified Domain Name (FQDN) or other moniker identifying the networked UPnP device or the gateway by name.

In one embodiment, the home network is assigned a routable IPv6 prefix address. Under current implementations of the IPv6 protocol, the IPv6 prefix is the upper 64 bits of the 128 bit address, and the suffix or lower 64 bits of the IPv6 address is assigned, to uniquely identify the external WAN side of the gateway 106. It will be appreciated that other analogous addressing schemes may be employed. In the illustrated embodiment, each device on the internal network that supports IPv6 takes the same prefix and appends a unique suffix to create an IPv6 address. Such an address is considered to fully route between any network devices. If a device such as the control point 108 on the external network does not have a FQDN for a device on the internal network, or complete global address, the external device may nonetheless contact the gateway to further identify the device desired on the internal network.

In one embodiment, the gateway 106 is configured to respond to queries to enumerate devices attached to the internal network 100. For example, the gateway may provide a web server and web page enumerating devices on the internal network. A control point 108 needs to obtain a device's 102, 104 XML Device Description Document (DDD) to read the device's available actions. In one embodiment, to get to the device from the external network 110, the gateway maintains a list of devices on a web page that points to the UPnP devices having global. Since the firewall aspect of the gateway should be blocking direct access to the desired device, the control point may read the device's DDD from the web server on the gateway. After the control point establishes a Set Session Key, in one embodiment, the firewall forwards UPnP traffic between the control point and a desired UPnP device 102, 104.

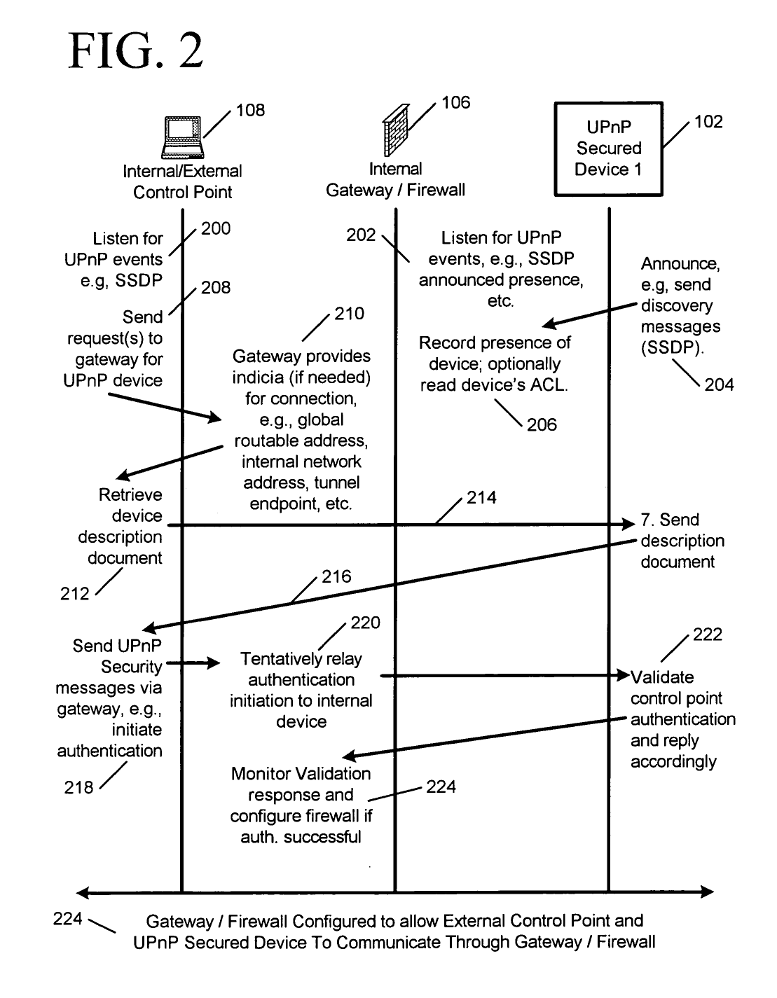

FIG. 2 illustrates a functional diagram for certain FIG. 1 devices (Internal UPnP Secured Device 102, Internal Gateway/Firewall 106, Internal/External Control Point 108) operating according to one embodiment. The illustrated operations show how a control point, such as Control Point 108, may start on an Internal network, e.g., FIG. 1 item 100, move on to an external network, e.g., FIG. 1 item 110, and then establish a secure communication session with a secured device

Assuming the devices 102, 106, 108 utilize the UPnP Security protocol, when a UPnP device such as device 102 attaches to a network, e.g., by completing a wireless or physical cable link, by activating networking software (stack), resuming from a low-power or off state, etc., the device announces its presence to the local network so that control points may elect to query the device for its capabilities and characteristics. Under the UPnP protocol, the attaching device issues a SSDP (Simple Service Discovery Protocol) presence announcement. Within the discovery packet(s) associated with the announcement is a Uniform Resource Identifier (URI) (sometimes referred to as a Uniform Resource Locator (URL)) to the announcing device's DDD.

The DDD outlines the announcing device's characteristics and abilities. Typically a device description incorporates the IP address of the announcing device. In one embodiment, the UPnP device implementation requirements are modified so that the DDD incorporates a FQDN for the announcing device along with, or in lieu of, the conventional IP address. This does not modify the core UPnP protocols. It will be appreciated by one skilled in the art that other discovery protocols provide corresponding arrangements for querying characteristics and abilities of a discovered device, and hence the phrase “device description” is intended to refer to a UPnP DDD as well as other descriptions provided by other discover techniques.

As illustrated, both the control point 108 and gateway 106 are configured to listen 200, 202 for various UPnP events, including such as the UPnP SSDP presence announcement. In the illustrated embodiment, the control point is assumed present on the internal network with the announcing device. When a UPnP secured device issues 204 its presence announcement, the gateway records (stores) 206 the announcement. In one embodiment, the gateway also inspects the device for an associated Access Control List (ACL), and if available, the gateway later uses the ACL to determine what external network 108 devices are authorized to communicate with the device, or what services are valid for the device 102. Similarly, in one embodiment, the control point 108 also records the announcement and hence has existing knowledge of a device 102 when the control point is on the external network.

It will be appreciated the control point 108 may choose to not store announcements, or that announcements may occur after the control point has left the internal network 100, and hence the control point may not have stored knowledge of devices on the internal network. In one embodiment, the gateway 106 is known by control points to be aggregating access to all devices on the internal network into a single point exposed to the outside, and hence the control point, when on an external network 110, may query the gateway for devices presently on the internal network. The control point contacts the gateway for this query by means outside of UPnP protocols, i.e. web based protocols.

Assuming the control point 108 cannot locate a desired device 102 on the internal network from outside, e.g., does not know the global address or FQDN for the desired device, the control point 108 then sends a query 208 to the gateway 106 to locate the desired device. Since the desired device is behind a gateway 106, the gateway receives the request. As noted above, in one embodiment (not illustrated), after recording 206 the presence announcement 204 from a secure UPnP device, if the gateway has been given access permission to read an Access Control List (ACL) of the secure device, it may cache that information on the gateway itself. When a secure control point contacts the gateway the gateway can verify whether the control point is authorized to communicate with the desired device. If permission is not present in the ACL, then the sent 208 request can be immediately discarded.

In the illustrated embodiment, the gateway 106 responds 210 to the sent 208 request with some indicia corresponding to the desired device 102, such as a global IPv6 address, a FQDN, Virtual Private Network tunnel endpoint (e.g., data for establishing a tunnel directly to the desired device), or other data needed by the control point for accessing the desired device. It will be appreciated that the response may vary depending on the information already known to the control point.

In the illustrated embodiment, after the connection indicia is received from the gateway 106, in the illustrated embodiment, the control point requests 212 device description data from the desired device 102. This request is received by the gateway and is forwarded 214 to the desired device, which in turn replies 216 with the device description data through the gateway. It will be appreciated that in the illustrated embodiment, the gateway acts as a proxy and conveys the device description data request 212 and response 216. It will be further appreciated that the request 212, forwarding, and response 216 are optional if the control point already knows the services of the desired device, such as may be the case since the control point may have already obtained the data while in contact with the internal network.

However, assuming the device description data is desired, once the control point has the data, the control point can inspect the services (and related devices) offered by the desired device, and assuming the desired device offers a service or device of interest to the control point, the control point can initiate 218 a secure communication session, e.g., seek to authenticate, with the desired device. Under the UPnP Security protocol, the control point issues a combination of actions well defined by the UPnP Security Working Committee, in which initiation 218 includes the control point sending a set session keys (SSK) request to the desired device.

As with the initial request 214, the gateway tentatively relays 220 the authentication initiation 218 to the desired device 102. Although the UPnP Security protocol does not provide for the request coming from an external network such as FIG. 1 network 110, by having the request relayed 220 to the desired device 102, the desired device may respond conventionally to the authentication. The desired device can attempt to validate the authorization credentials provided in the initiation 218 and reply 222 accordingly with an approval or disapproval acknowledgement. If we assume the control point and desired device both have global addresses, e.g., IPv6 or equivalent, then based on conventional routing techniques, since the reply is destined for an off-network, e.g., external, address, the reply routes through the gateway 106 on its way to the control point. Thus, after relaying the initiation 218, the gateway can then monitor 224 for the reply 222. In this description and claims that follow, monitoring 224 is intended to broadly encompass various techniques for determining the reply 222.

Assuming that the gateway monitors 224 an approval acknowledgement reply 222, in the illustrated embodiment, the gateway then configures itself, e.g., sets an appropriate filter or firewall rule, to allow subsequent communication, e.g., subsequent UPnP actions, to occur between the control point and the desired device 102, while otherwise maintaining security to prevent communication from unknown devices onto the internal network. Although the control point may have successfully authenticated with the desired device, it is assumed the gateway filter or firewall rule is point to point, and thus prevents communication from the control point to any other device other than the one from which the approval acknowledgement was monitored 224.

If the gateway 106 monitors 224 an authentication failure, e.g., the reply 222 is a disapproval acknowledgement, in one embodiment, the gateway sets a filter or firewall rule to block further communications from the external control point 108. Alternatively, the gateway may simply watch contact from the control point after monitoring the authentication disapproval to determine whether the control point is engaging in some sort of attack against the gateway or internal network devices.

It will be appreciated that a mobile control point 108 may have first established a secured communication session with the desired device 102 when the control point was on the internal network 100, and then been suspended and woken with its network interface having a new attachment to the external network 110. Typically, the control point would continue to send encrypted traffic in accord with the UPnP Security protocol, e.g., send SOAP actions. Assuming the control point is using a global address, FQDN, or the like to address network traffic for the desired device, this traffic will now route to the gateway and appear on its “external WAN” side. In one embodiment, the gateway will respond to the first such UPnP Security SOAP action with an error, e.g., “781—No Such Session” or equivalent. This error will force the control point to seek to reestablish a secured session with the secure device by sending the standard actions associated with setting of session keys. This should all occur without any user intervention.

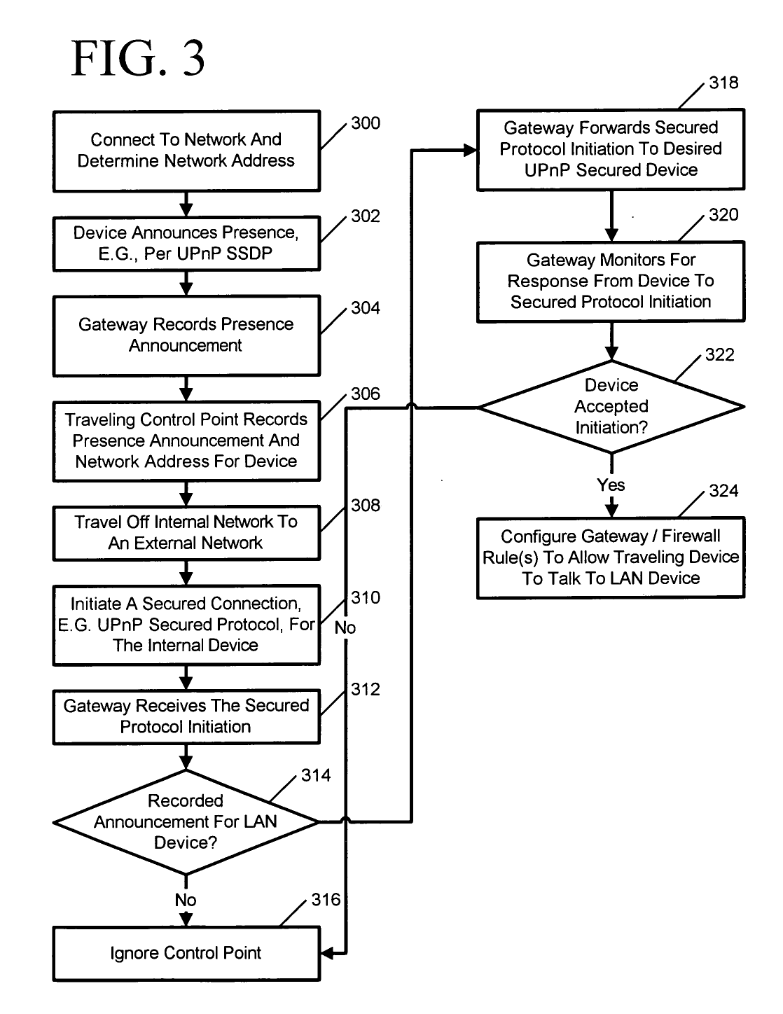

FIG. 3 illustrates a flowchart according to one embodiment. As discussed above, a system of devices such as in FIG. 1 may operate in accord with FIG. 2 to allow control points to interface with “smart” gateways that are configured to dynamically create and destroy gateway filters to support the UPnP Security protocol for devices that have moved onto an external network. In effect, a smart gateway may operate as a “friendly man-in-the-middle” as it allows authentication credentials and challenges to be exchanged between an external and internal device, and if authentication is successful, the gateway then dynamically opens a communication port for subsequent messages—this port need not be the same port used for authentication. In such a case, a smart gateway may limit traffic to UPnP Security messages.

As illustrated, a device connecting to an internal network determines 300 its network address. In one embodiment, this address is a globally routable IPv6 address, as such an address simplifies contacting the device from an external network. However, it may be an address private to the internal network, such as a non-routable IPv4 address such as 192.168x.x. As discussed above, various techniques may be employed to identify and contact devices lacking a globally routable address, and a gateway to the internal network may be used to proxy and/or tunnel traffic to the device.

Once the device has a network address, it announces 302 its presence on the internal network. Under the UPnP protocol, the device issues a SSDP (Simple Service Discovery Protocol) presence announcement, in which is included the device's network address. A gateway on the internal network records 304 the presence announcement. As discussed above, the gateway may serve as one intermediary, e.g., firewall, between the internal network and an external network, and also act as an aggregator of devices and services offered by secured devices of the internal network.

A traveling control point, e.g., a control point that is to leave the internal network, also records 306 the presence announcement and network address for the device. It will be appreciated that this step is redundant under UPnP in that the network address is incorporated within the presence announcement. In a non-UPnP embodiment, or in a modified UPnP embodiment, the recorded network address may be different from the one advertised by the device. For example, the gateway may be configured to determine the device is advertising a non-routable private network address, and the gateway may then issue a special broadcast (e.g. a re-advertisement) indicating a substitute globally routable address that should instead be used from the external network. This address would then be recorded 306 in lieu of the address advertised by the device.

When the control point travels 308 off the internal network to an external network, which of course may be an internal network for a different location, the control point initiates 310 a secured connection to the device at its recorded 306 network address. Assuming use by the control point of the UPnP Secured protocol, the initiation 310 includes SOAP-based (or equivalent) network traffic corresponding to a UPnP Security Set Session Keys (SSK) request. The gateway receives 312 the initiation 310 and checks to determine if 314 the gateway has recorded a presence announcement, e.g., announcement 302, from the device attempting to be accessed by the control point.

If no announcement has been recorded, then the initiation 310 may be part of some sort of attack, such as a Denial of Service (DoS) attack, or an attempt to illicitly gain access to network resources. Thus, in one embodiment, the initiation is discarded and the control point ignored 316. However, if the gateway determines it has a recorded presence announcement for the device desired by the external control point, the gateway tentatively forwards 318 the initiation to the desired device. Note that it is assumed in the illustrated embodiment that the control point learned of the device while being on the internal network, however as discussed above, there are techniques for querying the gateway that may be applied in accord with the illustrated embodiment.

The gateway then monitors 320 for a response from the device responsive to the initiation 310. If 322 the device accepted the initiation, e.g., it sent, broadcasted, etc. an approval acknowledgement, then the gateway configures 324 a filter (or firewall rule) to allow the traveling control point to communicate with the device. However, if 322 the gateway monitors a disapproval acknowledgement, or perhaps simply did not see an approval acknowledgement within a prescribed timeframe in which such approvals need to be issued, then the gateway ignores 316 the control point. It will be appreciated that ignoring 316 the control point may include configuring gateway filters to block network traffic from the traveling control point.

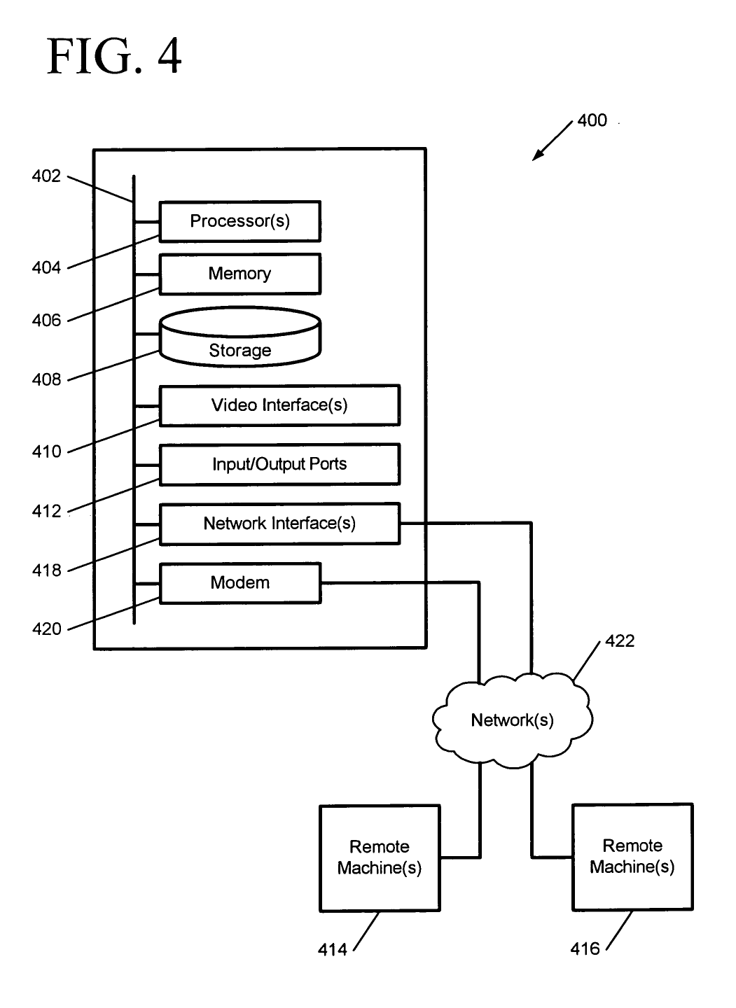

FIG. 4 and the following discussion are intended to provide a brief, general description of a suitable environment in which certain aspects of the illustrated invention may be implemented. As used herein below, the term “machine” is intended to broadly encompass a single machine, or a system of communicatively coupled machines or devices operating together. Exemplary machines include devices such as the devices 102-108, 114-118 of FIG. 1, personal computers, workstations, servers, portable computers, handheld devices (e.g., Personal Digital Assistant (PDA), telephone, tablets, etc.), and may also include devices such as transportation devices, including private or public transportation such as automobiles, trains, airplanes, cabs, etc.

Typically, the environment includes a machine 400 that includes a system bus 402 to which is attached processors 404, a memory 406, e.g., random access memory (RAM), read-only memory (ROM), or other state preserving medium, storage devices 408, a video interface 410, and input/output interface ports 412. The machine may be controlled, at least in part, by input from conventional input devices, such as keyboards, mice, etc., as well as by directives received from another machine, biometric feedback, interaction with a virtual reality environment, or other input source or signal.

The machine may include embedded controllers, such as programmable or non-programmable logic devices or arrays, Application Specific Integrated Circuits, embedded computers, smart cards, and the like. The machine may utilize one or more connections to one or more remote machines 414, 416, such as through a network interface 418, modem 420, or other communicative coupling. Machines may be interconnected by way of a physical and/or logical network 422, such as the networks 100, 110, 112 of FIG. 1, and which may include the Internet, and local and wide area networks (LAN, WAN). One skilled in the art will appreciate communication may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, volatile and/or non-volatile memory 406, or in storage devices 408 and their associated storage media, including hard-drives, floppy-disks, optical storage, tapes, flash memory, memory sticks, digital video disks, biological storage, etc. Associated data may be delivered over transmission environments, including network 422, in the form of packets, serial data, parallel data, propagated signals, etc., and may be used in a compressed or encrypted format. Associated data may be used in a distributed environment, and stored locally and/or remotely for access by single or multi-processor machines.

Thus, for example, with respect to the illustrated embodiments, assuming machine 400 embodies the gateway 106 of FIG. 1, and network 422 includes the external network 110, then remote machines 414, 416 may respectively be secured device 102 of the internal network 100 and the external control point 108 seeking to access the secured device 102 by way of the network 422. It will be appreciated that remote machines 414, 416 may be configured like machine 400, and therefore include many or all of the elements discussed for machine.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

1. A method for an intermediary selectively coupling an external network and an internal network to dynamically generate filter rules to facilitate establishing an end to end secure session connection between a first device on the internal network and a second device of the external network, the method comprising:
receiving a secure session establishment request by the second device on the external network to establish a secure communication session with the first device on the internal network;
forwarding the secure session establishment request to the first device;
monitoring the internal network for an approval or disapproval acknowledgement by the first device for the secure session establishment request; and
if an approval authentication acknowledgement is monitored, then configuring a first filter rule of the intermediary to allow communication between the first and second devices through the intermediary.

2. The method of claim 1, further comprising:
determining a presence advertisement for the first device has been received before forwarding the secure session establishment request to the first device.

3. The method of claim 2 wherein the presence advertisement is delivered in accordance with the UPnP Simple Service Discovery Protocol (SSDP).

4. The method of claim 1, further comprising:
receiving network traffic from the second device corresponding to the second device requesting a UPnP Device Description Document from the first device.

5. The method of claim 1, further comprising:
receiving a service request from the second device for the first device, the service request having an associated communication port for performing the service;
determining the service request identifies a service advertised by the first device in a device description document; and
configuring a second filter rule to allow communication between the first device and the second device using the associated communication port.

6. The method of claim 1, further comprising:
providing the second device with an indicia for use by the second device in establishing a communication link to the first device.

7. The method of claim 6, wherein the indicia is a selected one of a globally routable Internet Protocol (IP) address, or an internal network address non-routable on the external network.

8. The method of claim 1, wherein communication within the internal network is in accord with an IPv6 compatible Internet Protocol (IP).

9. The method of claim 1, further comprising:
retrieving an Access Control List (ACL) from the first device, the ACL including an identification of devices authorized to establish communication sessions; and
determining based at least in part on the ACL the second device is authorized to establish the secure communication session with the first device before forwarding the secure session establishment request to the first device.

10. The method of claim 1, further comprising:
receiving network traffic from the second device corresponding to a previous secure communication session established when the second device was previously on the internal network; and
responding to said network traffic with an error such that the second device attempts to re-establish a secure communication session from the external network.

11. The method of claim 1, further comprising:
establishing the end to end secure session connection between the first device on the internal network and the second device of the external network in a single end to end secure session connection between said first and second devices.

12. A method for communicating with a device by way of an intermediary selectively coupling an external network and an internal network, comprising:
receiving a presence advertisement for the device;
storing a network address associated with the first device;
determining services offered by the device; and
while on the external network, issuing a secure communication initiation request to the device via the intermediary.

13. The method of claim 12, wherein the intermediary is configured to:
forward the request to the device;
monitor for an approval or disapproval authentication acknowledgement to the request; and
configure a filter of the intermediary to allow communication with the device if an approval authentication acknowledgement is received.

14. The method of claim 13, wherein the intermediary is further configured to configure the filter to block communication with the device is a disapproval authentication acknowledgement is received.

15. The method of claim 12 wherein the presence advertisement is received while on the internal network.

16. The method of claim 12, wherein while on the internal network, the method further comprising requesting a description of services offered by the device.

17. The method of claim 16, wherein the description of services is requested from the intermediary.

18. The method of claim 12, wherein while on the external network, the method further comprising requesting a description of services offered by the device.

19. The method of claim 18, wherein the description of services is requested from the intermediary.

20. The method of claim 12, further comprising:
receiving an approval authentication acknowledgement to the request; and
responsive to the approval, requesting a service of the device.

21. The method of claim 12, wherein the network address associated with the first device is a globally unique network address having an address portion identifying the intermediary.

22. The method of claim 12, wherein a traveling control point performs the method for communicating with the device.

23. A system of devices communicatively coupled with an internal network and an external network via a gateway, comprising:
a first device, communicatively coupled to the internal network, offering services;
a second device selectively coupled with the internal and external networks, the second device seeking a service of the first device, wherein when requesting the service, said requesting includes sending a secure communication initiation request to the first device to facilitate establishing a secure communication session with the first device; and
an intermediary selectively communicatively coupling the first and second devices, wherein the intermediary is configured to receive a secure communication initiation request from the second device over the external network and forward the request to the first device.

24. The system of claim 23, wherein the intermediary is further configured to monitor the first device for an approval or disapproval authentication acknowledgement for the request, and to configure a filter of the intermediary controlling communication over the first network from the first device based at least in part on a monitored authentication acknowledgement.

25. The system of claim 23, wherein the first device communicates with the second device in accord with the UPnP Security Protocol.

26. The system of claim 23, wherein the secure communication initiation request corresponds to a UPnP Set Session Key (SSK) request.

27. An article comprising a machine-accessible media having associated data for an intermediary selectively coupling an external network and an internal network to dynamically generate filter rules to facilitate establishing an end to end secure session connection between a first device on the internal network and a second device of the external network, wherein the data, when accessed, results in the intermediary performing:
receiving a secure session establishment request by a second device on the external network to establish a secure communication session with a first device on the internal network;
forwarding the secure session establishment request to the first device;
monitoring the internal network for an approval or disapproval acknowledgement by the first device for the secure session establishment request; and
if an approval authentication acknowledgement is monitored, then configuring a first filter rule of the intermediary to allow communication between the first and second devices through the intermediary.

28. The article of claim 27, wherein the data further includes data, which when accessed, results in the intermediary performing:
determining a presence advertisement for the first device has been received before forwarding the secure session establishment request to the first device.

29. The article of claim 27, wherein the data further includes data, which when accessed, results in the intermediary performing:
receiving a service request from the second device for the first device, the service request having an associated communication port for performing the service;
determining the service request identifies a service advertised by the first device in a device description document; and
configuring a second filter rule to allow communication between the first device and the second device using the associated communication port.

30. The article of claim 27, wherein the data further includes data, which when accessed, results in the intermediary performing:
providing the second device with an indicia for use by the second device in establishing a communication link to the first device.

31. The article of claim 27, wherein the data further includes data, which when accessed, results in the intermediary performing:
retrieving an Access Control List (ACL) from the first device, the ACL including an identification of devices authorized to establish communication sessions; and
determining based at least in part on the ACL the second device is authorized to establish the secure communication session with the first device before forwarding the secure session establishment request to the first device.

32. An article comprising a machine-accessible media having associated data for communicating with a device by way of an intermediary selectively coupling an external network and an internal network, wherein the data, when accessed, results in a machine performing:
receiving a presence advertisement for the device;
storing a network address associated with the first device;
determining services offered by the device; and
while on the external network, issuing a secure communication initiation request to the device via the intermediary.

33. The article of claim 32, wherein the data further includes data, which when accessed by the machine, results in the machine performing:
receiving the presence advertisement while on the internal network.

34. The article of claim 32, wherein the data further includes data, which when accessed by the machine, results in the machine performing, while on the internal network, requesting a description of services offered by the device.

35. The article of claim 32, wherein the data further includes data, which when accessed by the machine, results in the machine performing, while on the external network, requesting a description of services offered by the device.

36. Machine-accessible information for an intermediary selectively coupling an external network and an internal network embodied in a propagated signal which, when accessed, results in the intermediary performing:
receiving a secure session establishment request by a second device on the external network to establish a secure communication session with a first device on the internal network;
forwarding the secure session establishment request to the first device;
monitoring the internal network for an approval or disapproval acknowledgement by the first device for the secure session establishment request; and
if an approval authentication acknowledgement is monitored, then configuring a first filter rule of the intermediary to allow communication between the first and second devices through the intermediary.

37. The propagated signal of claim 36, wherein the machine-accessible information further includes information, which when accessed, results in the intermediary performing:
receiving a service request from the second device for the first device, the service request having an associated communication port for performing the service;
determining the service request identifies a service advertised by the first device in a device description document; and
configuring a second filter rule to allow communication between the first device and the second device using the associated communication port.
